(19) United States
(12) Patent Application Publication
(10) Pub. No.: US 2008/0134943 A1
(43) Pub. Date: Jun. 12, 2008

(54) Encapsulation Medium

(76) Inventors: Ian Hugh Godfrey, Whitehaven (GB); Martin Hayes, Manchester (GB)

Correspondence Address: MOORE & VAN ALLEN PLLC, P.O. BOX 13706, Research Triangle Park, NC, 27709, US

(21) Appl. No.: 11/574,324

(22) PCT Filed: Sep. 1, 2005
(86) PCT No.: PCT/GB05/03376

§ 371 Date: Aug. 23, 2007

(30) Foreign Application Priority Data
Sep. 4, 2004 (GB) 0419682.0

(51) Int. Cl. C04B 28/06; G21F 9/16

(52) U.S. Cl. 106/692; 588/252; 588/3

(57) ABSTRACT

The invention provides a cementitious composition comprising at least one sulphoaluminate cement which comprises a sulphoaluminate salt of an alkaline earth metal, the cementitious composition being essentially free of other cementitious components. Preferably the at least one sulphoaluminate salt of an alkaline earth metal comprises calcium sulphoaluminate and the cementitious composition additionally comprises at least one further salt of an alkaline earth metal, preferably calcium sulphate. The invention also provides a method for the encapsulation of materials, the method comprising treating the materials with the said at least one cementitious composition. Preferably, the materials which are encapsulated according to the method of the invention comprise waste materials generated in the nuclear processing industry comprising amphoteric reactive metals.

### FIELD OF THE INVENTION

This invention relates to a novel cementitious material and its use in the treatment of waste by encapsulation. More specifically, it is concerned with a cementitious material which comprises a sulphoaluminate cement, and a method for the encapsulation of waste products produced in the nuclear industry by treatment of the said wastes with the said cementitious material.

### BACKGROUND TO THE INVENTION

Encapsulation in cementitious media has proved to be an especially favoured method for the disposal of certain waste materials; specifically it provides a suitable means for the conversion of these materials into a stable and safe form, which allows for long-term storage and/or ultimate disposal. The technique can find particular application in the nuclear industry, where the highly toxic nature of the materials involved, and the extended timescales over which the toxicity is maintained, are the principal considerations when devising safe disposal methods.

The use of cement based injection grouting in the construction industry is well known from the prior art. Thus, EP-A-412913 teaches the use of a Portland Cement based grout in the consolidation of concrete structures affected by fine cracks, providing a cost-effective means of infilling both superficial and deeper fissures and cavities in such structures, including such as buildings, bridges and dams. Similarly, ZA-A-9209810 is concerned with a pumpable, spreadable grouting composition incorporating a cementitious and/or pozzolanic or equivalent material, and its application in sealing fissures and cracks, back-filling, providing mass fills in civil and mining works, or lining tunnels.

Also disclosed in the prior art are hydraulic setting compositions comprising particles of Portland Cement together with fine particles of silica fume containing amorphous silica, which are the subject of EP-A-534385 and are used in the production of concrete, mortar or grout having improved fluidity, whilst GB-A-2187727 describes a rapid gelling, hydraulic cement composition which comprises an acrylic gelling agent, a fine filler and Portland Cement, this composition being thixotropic and finding particular application in the formation of bulk infills for underground mining, and in the filling of voids and cavities in construction or civil engineering. A composition which also is useful in general building and construction work, and as an insulating material comprises a particulate filler, cellulose fibres and a cementitious binder, and is disclosed in GB-A-2117753.

Whilst the majority of these compositions of the prior art have a requirement for the addition of water, EP-A-801124 is concerned with a dry mixture, used for fine soil injection grout preparation, the mixture comprising fillers which do not react with water, cement and deflocculant; on addition of water, an agglomerate-free fine grout is formed, and this is easily injected into fine soil.

Thus, the use of these grouting materials in applications related to civil engineering is well known. Subsequently, however, in WO-A-03/056571, there is disclosed the use of such grouting materials in the encapsulation of fine particulate sized wastes, many of which had previously proved to be particularly problematic to encapsulate. This had been of especial concern in the nuclear industry where, in view of the nature of the waste products, much emphasis is laid on ensuring that procedures are completed efficiently and successfully before disposal of the waste products.

The method of WO-A-03/056571, which provides for the encapsulation of fine particulate materials which by the treatment of these materials with at least one microfine hydraulic inorganic filler, allows the drawbacks associated with previous procedures—which had relied on removing the waste materials from the containers in which they had been stored and mixing them in drums with the encapsulation material, or subjecting them to vibro-grouting techniques—to be overcome, and provides a treatment method for wastes of this type which affords much greater efficiency, convenience and safety in handling, and has a consequent beneficial effect both in terms of environmental considerations and cost. Thus, it is possible, by use of the method of WO-A-03/056571, to encapsulate many waste materials in a stable concrete monolith having a high degree of strength and retaining its stability over a period of many years.

It is a general feature of the compositions and methods of the prior art, however, that problems are encountered in the encapsulation of materials which are subject to corrosion, primary examples of such materials being reactive metals, most particularly amphoteric reactive metals such as aluminium. More specifically, in the nuclear processing industry, significant difficulties are encountered in the treatment of legacy reactive metal wastes, and also legacy wastes containing high levels of a wide range of organic and/or inorganic solids. The problems arise as a consequence of corrosion of the metallic residues over the course of time, with a resulting deleterious effect on the strength and stability of the encapsulated structures. Specifically, this is observed in the case of concrete monoliths, wherein deterioration of the structures is noted over a period of time.

Conventionally, the treatment of reactive radioactive metallic wastes has been carried out by means of encapsulation in cement formulations based on Ordinary Portland Cement (OPC). However, these OPC based cements provide cementitious systems which have a high internal pH, and it has now been established that this high internal pH may lead to high metallic corrosion rates in the cement; clearly, this corrosion could significantly impact on waste loadings and/or long term product quality.

Thus, the present inventors have sought to provide a cementitious composition which could be used for the treatment of reactive radioactive metallic wastes, and other waste materials comprising reactive metallic residues, and which would provide a product showing high durability, good thermal stability and low permeability, low corrosion rates and the potential to retain a range of waste materials. It has now been found that such characteristics may be achieved by the use of a novel cementitious composition based on sulphoaluminate cements.

Commercial cements are available which comprise calcium sulphoaluminate (CSA), and calcium sulphate in combination with Ordinary Portland Cement (OPC), and such materials form the basis of commercial shrinkage compensating cements. However, these systems have a high internal pH and, consequently, offer little real advantage over conventional OPC cements for reactive metal immobilisation. As a result, studies of systems free of OPC were carried out in order to assess their potential value for use in such circumstances, and it was found that significant reductions in internal pH, and in corrosion rates, could be achieved.

### STATEMENTS OF INVENTION

Thus, according to a first aspect of the present invention, there is provided a cementitious composition comprising at least one sulphoaluminate cement which comprises a sulphoaluminate salt of an alkaline earth metal, said cementitious composition being essentially free of other cementitious components.

Specifically, the invention provides a cementitious composition for use as an encapsulating material, said cementitious composition being essentially free of cementitious components which provide a high internal pH. It is preferred that the pH of the composition should not be above 11.5, more preferably not above 11, and most preferably, should be in the range of from 9.5-11, especially preferably from 10-11.

In this context it is particularly desirable that the cementitious composition should be essentially free of lime-based cementitious components which comprise calcium oxide and/or calcium hydroxide (quicklime and/or slaked lime) and/or OPC. It is also preferred that no organic materials, particularly organic polymeric emulsions, should be added to the encapsulating material

Preferably said at least one sulphoaluminate salt of an alkaline earth metal comprises calcium sulphoaluminate.

Preferred cementitious compositions additionally comprise at least one further salt of an alkaline earth metal, preferably a calcium salt. A particularly suitable material in this context is calcium sulphate, which is optionally hydrated, i.e. in the form of gypsum (CaSO₄.2H₂O). Further possible additives include, for example, magnesium hydroxide, which may provide improved fluidity.

One or more additional inorganic fillers may optionally be added to the cementitious composition; suitable fillers include blast furnace slag, pulverised fuel ash, finely divided silica, limestone, and organic and inorganic fluidising agents.

The sulphoaluminate cement preferably has a surface area in the range from 100 to 700 m²/kg, more preferably between 200 and 500 m²/kg, and most preferably from 300 to 450 m²/kg. Additional components in the composition preferably have particle sizes anywhere in the range of from 10 to 1000 μm. Most preferably, at least 80% of the particles of said components have a particle size below 75 μm. A suitable composition may, for example, comprise at least one sulphoaluminate salt of an alkaline earth metal in combination with gypsum and pulverised fuel ash (PFA), wherein about 86% of the gypsum particles have a particle size of less than 75 μm, and roughly 88% of the PFA particles have a particle size below 45 μm.

The cementitious composition is typically provided in the form of an aqueous composition; the water content of the composition may be up to 75%, but is preferably in the region of 30 to 75%, most preferably from 50 to 70% (w/w).

According to a second aspect of the present invention there is provided a method for the encapsulation of materials, said method comprising treating said materials with at least one cementitious composition according to the first aspect of the invention.

The method of the invention may be used for the encapsulation of a wide range of materials including, for example, waste materials and ion exchange resins, but it finds particular application in the treatment of materials comprising reactive metals, including metallic residues. Specifically, said reactive metals comprise amphoteric reactive metals. A particularly favoured example of an amphoteric reactive metal in this context is aluminium. Specifically, in such cases, it is important that the cementitious composition should be essentially free of cementitious components which provide a high internal pH, and that the pH of the composition should preferably not be above 11.5, most preferably not above 11.

Preferably, the materials which are encapsulated according to the method of the second aspect of the invention comprise waste materials, most particularly waste materials which are generated in the nuclear processing industry. In the context of the treatment of such waste materials, it is preferred that the waste materials should be encapsulated with a cementitious composition according to the first aspect of the invention, wherein the cementitious composition is essentially free of other cementitious components.

Specifically, in the case of the treatment of waste materials which are generated in the nuclear processing industry, it is required that the pH should not fall to a level at which other metals, principally uranium and plutonium, become solubilised. Thus, in the treatment of waste materials generated in the nuclear processing industry, it is desired that the pH of the cementitious composition should be in the range of from 9.5 to 11.5, more preferably from 9.5 to 11, most preferably from 10 to 11. In this context it is particularly desirable that the cementitious composition should be free of lime-based cementitious components which comprise calcium oxide and/or calcium hydroxide (quicklime and/or slaked lime) and/or OPC.

It is preferred that the cementitious composition should be provided in the form of an aqueous composition for the treatment of the waste material. Thus, for example, the cementitious composition may be pumped under pressure through the waste materials in order to ensure that they become intimately encapsulated; in this way, the filler is able to fill the very small interstitial cavities in the waste, thereby achieving intimate encapsulation without the need to remove the materials from their container. More preferably, however, encapsulation is achieved by means of either a vibro or non-vibrogrouting direct encapsulation process or an in-drum mixing process.

### DESCRIPTION OF THE INVENTION

The composition according to the first aspect of the invention finds specific application in the encapsulation of ion exchange resins and reactive metallic residues, specifically in the encapsulation of amphoteric reactive metallic residues, such as those which contain aluminium. The composition finds particular use in the encapsulation of a variety of waste materials, including various chemical wastes, but is principally of value in the encapsulation of waste materials generated in the nuclear processing industry. Other possible applications include the encapsulation of aluminium bars employed in the reinforcement of structural cement, which is used in the construction industry.

The method according to the second aspect of the present invention may be applied to the treatment of a wide range of waste materials. Of particular value, however, is the application of the method to the treatment of waste materials which comprise reactive metallic residues, most specifically amphoteric reactive metallic residues such as are associated with the presence of aluminium. The method finds particular application in the treatment of waste materials of this type which are encountered in the nuclear industry, in view of the particular safety and environmental concerns relating to the handling of such materials.

Studies were conducted using cementitious compositions containing the following components:
(a) CSA/CaSO₄;
(b) CSA/CaSO₄/Mg(OH)₂; and
(c) CSA/CaSO₄/Ca(OH)₂.

It was shown that whilst composition (c) showed very rapid setting times, rapid heat rise, and a pH of 12.8, compositions (a) and (b) provided reasonably high fluidity grouts with initial pH values ranging from 10.5 to 11.0. Subsequently, a corrosion test with aluminium indicated that system (a) significantly reduced the early corrosion rate of encapsulated metallic materials, even at high temperatures, when compared with conventional OPC based cements. It also appeared that the Mg(OH)₂ in composition (b) is relatively inert in the system, provided there is a sufficient supply of CaSO₄.

Further corrosion tests were then performed with two further CSA formulations, in order to assess the effects of different component ratios and additional components on the rate of corrosion of aluminium. The formulations had the following compositions:
(1) 60:40 CSA:CaSO₄.2H₂O; water/solids ratio 0.6.
(2) 75% (70:30 CSA:CaSO₄.2H₂O); 25% Pulverised Fuel Ash; water/solids ratio 0.65.

The studies therefore examined the corrosion rate of aluminium in CSA formulations, one of which (CSA 1) included only gypsum as an additive, whilst the other (CSA 2) additionally incorporated Pulverised Fuel Ash (PFA). Different water/solids ratios and calcium sulphoaluminate/gypsum ratios were also employed. In each of the tests, 0.5 m² of aluminium was incorporated in the CSA cements. The pH range of the encapsulant matrices in the plastic state was measured at between 9.5 and 11.

The results of these tests can be most conveniently gleaned from the accompanying diagrams, wherein:

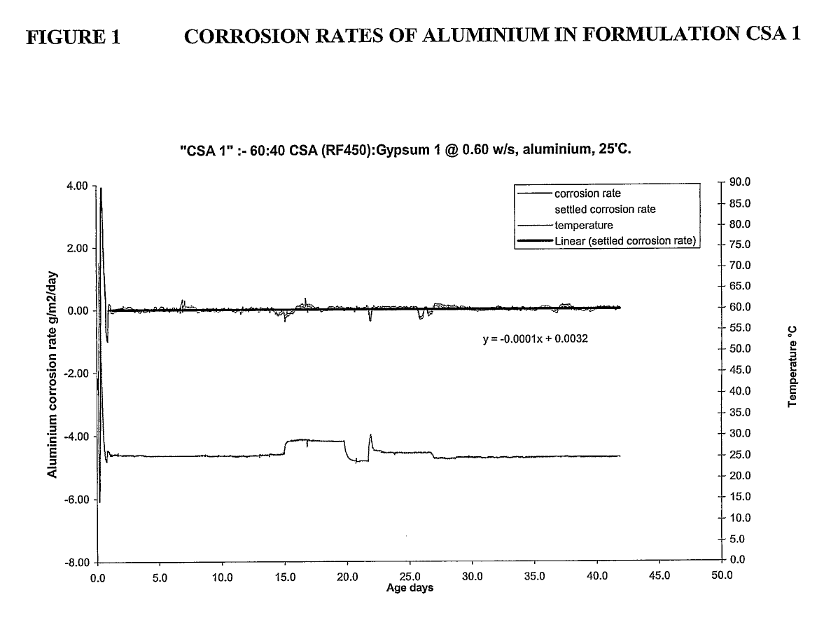

FIG. 1 shows the corrosion rate of aluminium over a period of time in formulation CSA 1; and

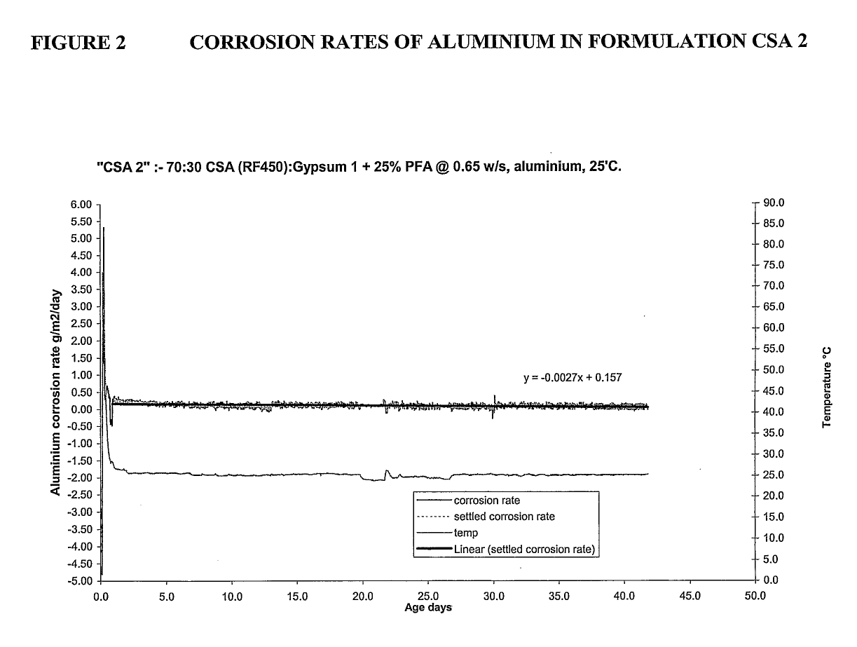

FIG. 2 shows the corrosion rate of aluminium over a period of time in formulation CSA 2.

It can be seen from these Figures that the corrosion rate of aluminium is negligible after the first day of a study conducted over a period of around 40 days. Furthermore, the rate of corrosion is at least an order of magnitude lower than that previously measured in OPC and other lime-based cements, thereby providing evidence of the particular suitability of the cementitious encapsulant formulations of the present invention for amphoteric metal encapsulation.

The composition and method of the invention find particular application in the immobilisation of nuclear wastes, where a lower internal pH offers significant processing and product quality advantages, more specifically in the treatment of reactive amphoteric metals by either a vibro or non-vibrogrouting direct encapsulation process or in-drum mixed process. Evaluation of a system comprising an amphoteric metal (aluminium) in a CSA cement formulation has indicated that the corrosion rate is significantly reduced and the invention has applications in the treatment of various hazardous wastes for which a relatively low pH could offer significant processing or product quality advantages.

The method of the present invention provides cementitious monoliths having high durability, good thermal stability and low permeability, which show low corrosion rates and the potential to retain a wide range of waste materials. Consequently, in the context of waste materials generated in the nuclear processing industry, these products have the potential to satisfy ultimate disposal criteria for current problematic historic wastes, and have improved leach characteristics, thereby yielding high cost benefits in terms of removing potential significant reworking to produce a final disposal package. In addition, the availability of a solution where problematic legacy wastes such as reactive metals can be treated should facilitate the acceleration of clean up programmes, thereby reducing both the length and cost of the storage period.

1. A method for the encapsulation of waste materials comprising reactive metals, said method comprising treating said waste materials with at least one cementitious composition which provides low rates of corrosion, wherein said cementitious composition comprises at least one sulphoaluminate cement which comprises a sulphoaluminate salt of an alkaline earth metal, and said cementitious composition is essentially free of cementitious components which provide a high internal pH.

2. A method as claimed in claim 1 wherein said cementitious composition is essentially free of lime-based cementitious components.

3. A method as claimed in claim 2 wherein said lime-based cementitious components comprise calcium oxide and/or calcium hydroxide (quicklime and/or slaked lime) and/or Ordinary Portland Cement.

4. A method as claimed in claim 1 wherein said cementitious composition comprises at least one sulphoaluminate cement which comprises a sulphoaluminate salt of an alkaline earth metal, wherein the pH of said cementitious composition is not above 11.5.

5. A method as claimed in claim 4 wherein the pH of the cementitious composition is in the range of from 9.5 to 11.5.

6. A method as claimed in claim 5 wherein said pH is in the range of from 9.5 to 11.

7. A method as claimed in claim 6 wherein said pH is in the range of from 10 to 11.

8. A method as claimed in claim 1 wherein said at least one sulphoaluminate salt of an alkaline earth metal comprises calcium sulphoaluminate.

9. A method as claimed in claim 8 wherein said cementitious composition additionally comprises at least one further salt of an alkaline earth metal.

10. A method as claimed in claim 9 wherein said at least one further salt of an alkaline earth metal comprises a calcium salt.

11. A method as claimed in claim 10 wherein said calcium salt comprises calcium sulphate.

12. A method as claimed in claim 11 wherein said calcium sulphate comprises hydrated calcium sulphate.

13. A method as claimed in claim 9 wherein said at least one further salt of an alkaline earth metal comprises magnesium hydroxide.

14. A method as claimed in claim 1 wherein said cementitious composition comprises at least one additional inorganic filler.

15. A method as claimed in claim 14 wherein said at least one additional inorganic filer comprises blast furnace slag, pulverised fuel ash, finely divided silica, limestone, or inorganic fluidising agents.

16. A method as claimed in claim 1 wherein said cementitious composition comprises at least one organic fluidising agent.

17. A method as claimed in claim 1 wherein the Sulphoaluminate cement has a surface area in the range from 100 to 700 m²/kg.

18. A method as claimed in claim 17 wherein said surface area is in the range from 200 to 500 m²/kg.

19. A method as claimed in claim 18 wherein said surface area is in the range from 300 to 450 m²/kg.

20. A method as claimed in claim 9 wherein at least 80% of particles of said additional components have a particle size below 75 μm.

21. A method as claimed in claim 1 wherein said cementitious composition is provided in the form of an aqueous composition for the treatment of the waste material.

22. A method as claimed in claim 21 wherein the water content of said aqueous composition does not exceed 75% (w/w).

23. A method as claimed in claim 22 wherein said water content is in the region of 30-75% (w/w).

24. A method as claimed in claim 23 wherein said water content is in the region of 50-70% (w/w).

25. A method as claimed in claim 1 wherein said cementitious composition is pumped under pressure through the waste materials.

26. A method as claimed in claim 25 wherein encapsulation is achieved by means of a vibro or non-vibrogrouting direct encapsulation process or an in-drum mixing process.

27. A method as claimed in claim 1 wherein said reactive metals comprise amphoteric reactive metals.

28. A method as claimed in claim 27 wherein said amphoteric reactive metal comprises aluminium.

29. A method as claimed in claim 1 wherein said reactive metals comprise reactive metallic residues.

30. A method as claimed in claim 1 wherein said waste materials comprise waste materials which are generated in the nuclear processing industry.

31. A method as claimed in claim 1 wherein said waste materials comprise ion exchange resins.

32. A method for the storage of a waste material comprising reactive metals, the method comprising:
encapsulating waste materials by treating said waste materials with at least one cementitious composition which provides low rates of corrosion, wherein said cementitious composition comprises at least one sulphoaluminate cement which comprises a sulphoaluminate salt of an alkaline earth metal, and said cementitious composition is essentially free of cementitious components which provide a high internal pH.

33. A cementitious monolith that encapsulates waste material comprising reactive metals fabricated by treating said waste materials with at least one cementitious composition which provides low rates of corrosion, wherein said cementitious composition comprises at least one sulphoaluminate cement which comprises a sulphoaluminate salt of an alkaline earth metal, and said cementitious composition is essentially free of cementitious components which provide a high internal pH.
